(19) United States
(12) Patent Application Publication
(10) Pub. No.: US 2016/0379592 A1
(43) Pub. Date: Dec. 29, 2016

(54) MOTOR VEHICLE COMPONENT TO UTILIZE A FONT OR CHARACTER RESOURCE OF A SEPARATE ELECTRONIC DEVICE

(71) Applicant: Airbiquity Inc., Seattle, WA (US)

(72) Inventors: Darrin L. Garrett, Kingston, WA (US); Jack William Bell, Seattle, WA (US)

(73) Assignee: Airbiquity Inc., Seattle, WA (US)

(21) Appl. No.: 15/191,382

(22) Filed: Jun. 23, 2016

Related U.S. Application Data
(60) Provisional application No. 62/184,697, filed on Jun. 25, 2015.

(51) Int. Cl. G09G 5/00; H04N 19/184; G06T 3/40; H04N 19/44

(52) U.S. Cl. CPC G09G 5/006; G09G 5/003; H04N 19/44; H04N 19/184; G06T 3/40; B60K 35/00

(57) ABSTRACT

In an example, a system includes a vehicle component (e.g., an automotive head unit) that is installed in a motor vehicle and a portable device (e.g., a cell phone) in the motor vehicle that is coupled with the motor vehicle. The vehicle component may include a screen and an image renderer, and the portable device may include a text renderer. The portable device may be configured to, in response to receiving a command to generate an image for the vehicle component, perform first operations to input data associated with the command into the text renderer to obtain a bitmap image and transmit the bitmap image or a representation thereof to the vehicle component. The vehicle component may be configured to perform second operations to input data of the bitmap image into the image renderer, and display an output of the image renderer on the screen.

### PRIORITY

This application claims benefit of U.S. Provisional Application No. 62/184,697 filed on Jun. 25, 2015, which is herein incorporated by reference in its entirety.

### COPYRIGHT NOTICE

©2015-2016 Airbiquity Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND

In-vehicle equipment may include computing resources (e.g. CPU resources and/or memory resources) selected by a manufacturer to support a first character set and associated font and font sizes. The in-vehicle equipment including the computing resources selected to support the first character set and associated font and font sizes may not necessarily have enough computing resources, e.g. enough memory, to support an additional second character set and associated font and font sizes.

An Automotive Original Equipment Manufacturer (OEM) may wish to leverage existing computing systems originally designed for a specific region/market in a new region/market. However, the OEM may be unable to do so because the existing on-board computing system does not have enough memory resources to support a different localized character set and associated font and font sizes. North American character sets are based on Roman alpha-numerics with the Roman alphabet being 26 characters. Chinese character sets range from 6000 characters for older character sets to 20,000 characters for the most resent Chinese character set. An OEM may not be able to use, in China, computing hardware and software specified to work in North America (for instance a system including a memory resource specified to work in North America).

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In-vehicle equipment may be configured to utilize character font resources of an available electronic device, such as a cellular phone carried in the vehicle or other personal portable device located in or nearby the vehicle (for instance coupled to the vehicle by a short range wireless connection or a wire), to display localized text characters on a display screen of the motor vehicle.

In an example, a system incorporates a personal portable device's memory resource capacity and text language localization capabilities to localize the text needed to be rendered for display by the vehicle's computing device. In an example, the system may include in-vehicle equipment and a personal portable device, and the system may process textual content into images on the personal portable device, which may natively support the text localization capability not present on the in-vehicle equipment.

In an example, the system uses the personal portable device's existing graphical framework API (application programming interface) to “take a picture” of the rendered text and form an image. Then, the in-vehicle equipment may obtain the image from the portable device for display onto the vehicle information screen. The portable device may contain multiple font sizes and associated memory resources to contain such character sets thus allowing the Automotive OEM to display varying size text which is properly localized without adding additional memory and/or CPU resource to the in-vehicle equipment.

In an example, a system includes a vehicle component (e.g., an automotive head unit) that is installed in a motor vehicle and a portable device (e.g., a cell phone) in the motor vehicle that is coupled with the motor vehicle. The vehicle component may include a screen and an image renderer, and the portable device may include a text renderer. The portable device may be configured to, in response to receiving a command to generate an image for the vehicle component, perform first operations including inputting data of the request into the text renderer to obtain a bitmap image and transmitting the bitmap image or a representation thereof to the vehicle component. The vehicle component may be configured to perform second operations including inputting data of the bitmap image into the image renderer, and displaying an output of the image renderer on the screen.

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates a system for a motor vehicle to utilize a font or character resource of a separate electronic device.

FIG. 2 illustrates a process that may be performed by the vehicle component of FIG. 1 to utilize the font or character resource of the electronic device.

FIG. 3 illustrates a process that may be performed by the electronic device of FIG. 1 to enable content to be displayed on a screen of the motor vehicle.

### DETAILED DESCRIPTION OF PREFERRED EMBODIMENTS

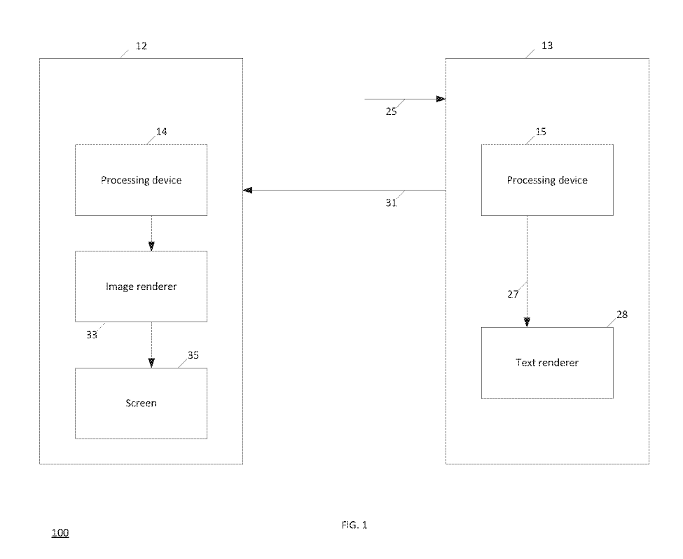

FIG. 1 illustrates a system for a motor vehicle to utilize a font or character resource of a separate electronic device.

The system 100 includes a motor vehicle component 12 (e.g., a single motor vehicle component, for instance, an automotive head unit or alternatively more than one separate, connected components of the motor vehicle). The system 100 includes a separate electronic device 13, such as a cell phone or other personal portable device located in or near the motor vehicle. In an example, the electronic device 13 is coupled to the vehicle, for instance, by USB® (universal serial bus) or another removable wire connection, or Bluetooth® or another short range wireless connection.

In some examples, the motor vehicle component 12 may be an automotive head unit, such as an OEM automotive head unit, which is typically located in the center of a dashboard and may provide a unified interface (e.g., software and/or hardware) for various components installed in (e.g., other OEM components) and/or located in or nearby an automobile (e.g., a personal portable device of a driver). Traditionally the term “head unit” may refer to a faceplate on a car stereo; however, more recently the term includes infotainment systems that include a general purpose processor and may communicate with a backend (e.g., a remote server) to implement additional functionality, which may include navigation, video, vehicle software updates, or the like, or combinations thereof In some examples, such a head unit may be installed in a motor vehicle after manufacture and/or original sale (an aftermarket automotive head unit).

The portable electronic device 13 may acquire an application, e.g., a cell phone “app”, for enabling utilization of cell phone font resources to display localized text characters on a vehicle display. The application may be downloaded to the electronic device 13 from a backend of the system 100, e.g., a remote server for centralized management of the motor vehicle component 12, or some other remote server, e.g., a server of an “app store”. The application, when installed and/or executed by a general purpose processor (not shown) of the electronic device 13, may provide processing device 15 (e.g., may transform the general purpose processor into a specially configured processing device).

The processing device 15 may receive a request 25 to utilize a text renderer 28 of the electronic device 13. In one example, the request 25 may originate from the processing device 14, but in another example the request 25 may originate from the backend. The processing device 15 may input data 27 of the request 25 into a text renderer 28 of the electronic device 13. The text render 28 is typically standard functionality of a cell phone, e.g., may be embedded software of a cell phone or other software distinct from the application (although in some examples the text render 28 may be provided by the application).

Rendered text of the text renderer 28 may be text shown on a screen of the electronic device 13 (e.g., a phone text display). In other examples, rendering may be in a view window in memory, e.g., a view window of a predetermined size in memory, in addition or instead of rendering on any screen of the electronic device 13.

An image may be generated by the electronic device 13 based on the rendered text. For instance, an image creator of the electronic device 13 may be utilized to obtain an image (such as a bitmap image) of the rendered text. The image creator is typically standard functionality of a cell phone, e.g., may be embedded software of a cell phone or other software distinct from the application (although in some examples the image creator may be provided by the application).

The processing device 15 may be configured to control the text render 28, the image creator, or any other component of the electronic device 13 based on requirements associated with the request 25. For instance, in some examples, the processing device 15 may determine at least one of a size of the area to display the text on the vehicle screen, the font, or the font size to use for the vehicle by information exchange with the motor vehicle and/or by configuration transmitted from a backend server. The information exchange may be prior to receiving the request 25 (prior configuration), in response to receiving the request 25, and/or the request 25 may specify one of these characteristics, or the like, or combinations thereof.

The processing device 15 may be configured to transmit data 31 representing the image to the motor vehicle, e.g., to the motor vehicle component 12. Transmission may be over any available data transport. The processing device 15 may be configured to compress the obtained image, which may reduce transport bandwidth requirements. The data 31 representing the image may include the compressed image, and in some examples the data 31 representing the image may include a header with correlating information, such as an identifier to correlate the data 31 to the request 25.

The processing device 14 may recover the image from the data 31 (for instance if the data 31 includes the compressed image). In an example, the image of the data 31 may be processed before displaying on screen 35. For instance, the processing device 14 may input the image into an image renderer 33 of the motor vehicle component 12. The image renderer 33 may render an image based on the image of the data 31. An output of the image renderer 33 may be coupled to a screen 35 of the motor vehicle component 12. In another example, the image from the data 31 may be directly displayed on screen 35.

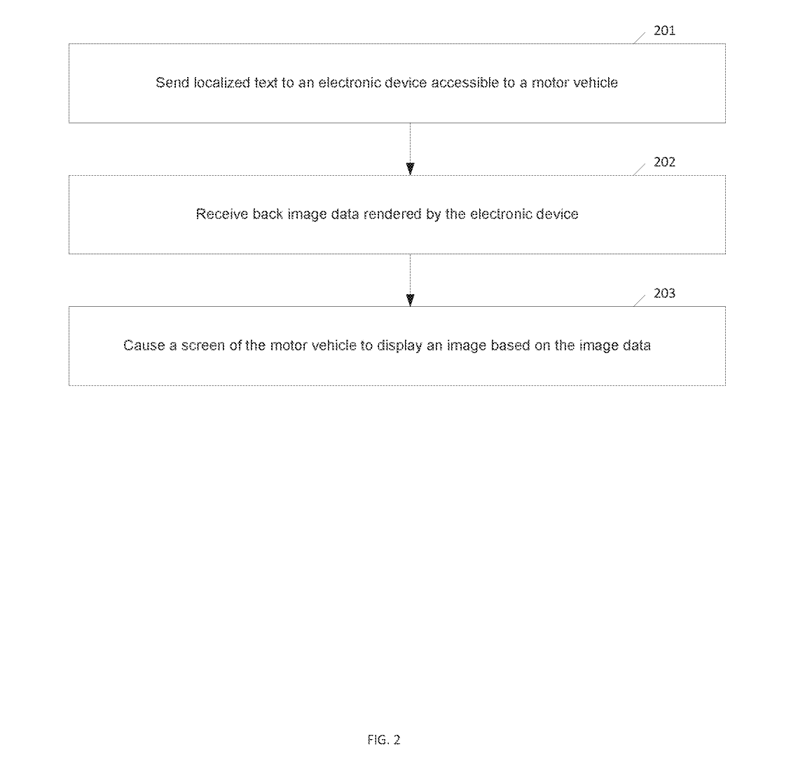

FIG. 2 illustrates a process that may be performed by the vehicle component of FIG. 1 to utilize the font or character resource of the separate electronic device.

In block 201, the processing device 14 may send localized text to an electronic device accessible to a motor vehicle. In block 202, the processing device 14 may receive back image data rendered by the electronic device. In block 203, the processing device may cause a screen of the motor vehicle to display an image based on the image data.

In an example, the motor vehicle component 12 may be configured to render, for display on a screen of the motor vehicle (e.g., installed in the motor vehicle), textual content using one or more first character sets of the motor vehicle component 12. The motor vehicle component 12 may have constrained computing resources (such as memory constrained computing resources) that are not sufficient for every other character set besides the one or more first character sets. The processing device 14 may receive back image data rendered by a personal portable device based on a second character set that is different than each character set of the one or more first character sets.

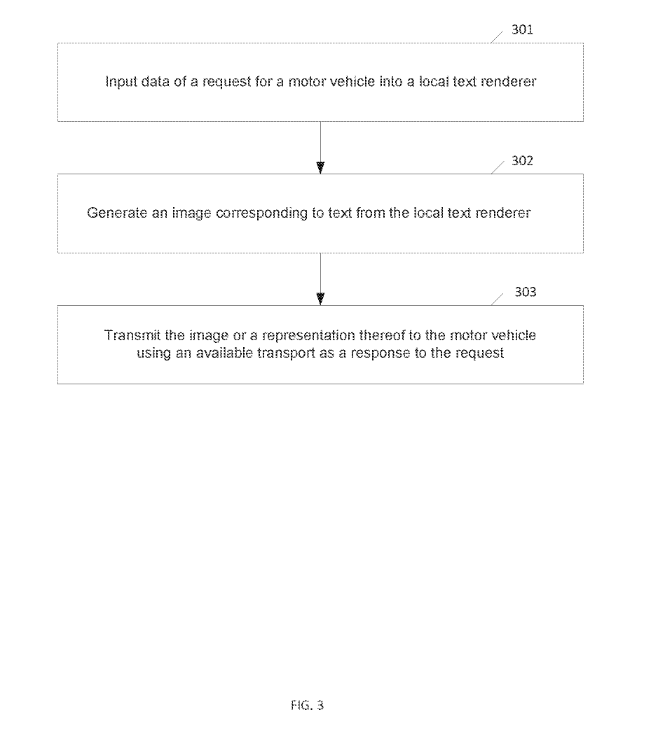

FIG. 3 illustrates a process that may be performed by the separate electronic device of FIG. 1 to enable content to be displayed on a screen of the motor vehicle.

In block 301, the processing device 15 may input data of a request for a motor vehicle into a local text renderer. In block 302, the processing device 15 may generate an image corresponding to text from the local text renderer. In block 303, the processing device 15 may transmit the image or a representation thereof to the motor vehicle using an available transport as a response to the request.

In an example, the electronic device 13 may establish a connection with the motor vehicle (the establishment by the electronic device 13 may initiated by either the electronic device 13 or another device such as the motor vehicle). The processing device 15 may be configured to, in response to receiving a command (from the motor vehicle and/or a backend) to generate an image for a vehicle component, perform first operations that include inputting data associated with the command into a local text renderer to obtain an image, such as a bitmap image (which may be obtained from an image creator that processes data based on an output of the local text renderer). The first operations may also include transmitting the image or a representation thereof to the vehicle component.

The processing device 14 may be configured to perform second operations that include inputting data of the image into a local image renderer and displaying an output of the image renderer on the screen. In some examples, the second operations may include transmitting a request including a characteristic to control rendering by the personal portable device (i.e. a request that includes or provides the command). The characteristic may include at least one of font, font size, or display area size associated with an information screen (e.g., logical screen) for the physical screen of the motor vehicle.

### EXAMPLES

Example 1 may include an automotive head unit installed in a motor vehicle, the automotive head unit comprising: a screen; and circuitry to render, for display on the screen, textual content using one or more first character sets of the automotive head unit, the circuitry configured to: send text to a personal portable device located in the motor vehicle; receive back image data to represent the text, the image data rendered by the personal portable device based on a second character set that is different than each character set of the one or more first character sets; and cause the screen to display an image based on the received image data.

Example 2 may include the subject matter of example 1, and the personal portable device is a cell phone located in the motor vehicle.

Example 3 may include the subject matter of any of examples 1-2, and the image data is received over a short range wireless connection.

Example 4 may include the subject matter of any of examples 1-3, and the image data is received over a removable wired connection.

Example 5 may include the subject matter of any of examples 1-4, and the text is associated with a character set of the one or more first character sets.

Example 6 may include the subject matter of any of examples 1-5, and the circuitry further configured to: decompress the image data to recover data; wherein said image is based on the recovered data.

Example 7 may include the subject matter of any of examples 1-6, and the circuity further configured to: transmit a request including a characteristic to control rendering by the personal portable device; wherein the image data is rendered responsive to the request.

Example 8 may include the subject matter of any of examples 1-7, and the characteristic includes at least one of font, font size, or display area size.

Example 9 is a computer-implemented method comprising: sending textual data to be displayed on a screen of a motor vehicle to an electronic device that is accessible to the motor vehicle via a wireless connection to utilize a font or character set resource of the electronic device; receiving image data rendered by the electronic device based on the textual data using the font or character set resource of the electronic device; and causing the screen of the motor vehicle to display an image based on the received image data.

Example 10 includes the subject matter of example 9, and the font or character resource of the electronic device comprises a text renderer, and the computer-implemented method further comprises: inputting the textual data into the text renderer; and inputting data based on an output of the text rendered into an image creator of the electronic device to generate the image data.

Example 11 is a system, comprising: a vehicle component that is installed in a motor vehicle, the vehicle component including a screen and an image renderer; and a portable device configurable to establish a connection with the motor vehicle, the portable device including a text renderer and configured to, in response to receiving a command to generate an image for the vehicle component, perform first operations to: input data associated with the command into the text renderer to obtain a bitmap image; and transmit the bitmap image or a representation thereof to the vehicle component; wherein the vehicle component is configured to perform second operations to: input data of the bitmap image into the image renderer; and display an output of the image renderer on the screen.

Example 12 includes the subject matter of example 11, and the first operations are further to capture rendered text of a screen of the portable device to obtain the bitmap image.

Example 13 includes the subject matter of any of examples 11-12, and the first operations are further to capture rendered text of a view window associated with a memory of the portable device to obtain the bitmap image.

Example 14 includes the subject matter of any of examples 11-13, and the view window is of a predefined size.

Example 15 includes the subject matter of any of examples 11-14, and the first operations are further to compress the bitmap image to generate the representation of the bitmap image, and wherein the second operations are further to recover the bitmap image in response to receipt of the representation of the bitmap image.

Example 16 includes the subject matter of any of examples 11-15, and a memory of the portable device retains a superset of character sets stored on the vehicle component.

Example 17 includes the subject matter of any of examples 11-16, and a memory of the portable device stores a first character set utilized by the text renderer responsive to the input of the data, the first character set different than any second character sets stored on a memory of the motor vehicle.

Example 18 includes the subject matter of any of examples 11-17, and a memory of the portable device stores first font information corresponding to a font or font size, the first font information different than any second font information stored on any memory of the vehicle component, wherein the first font information is utilized by the text renderer responsive to the input of the data.

Example 19 includes the subject matter of any of examples 11-18, and the portable device is further configured to communicate with a backend to obtain configuration information and the first operations are further to control the text render based on the obtained configuration to obtain the bitmap image.

Example 20 includes the subject matter of any of examples 11-19, and the portable device are further to obtain configuration information from at least one of the motor vehicle or a remote server and the first operations are further to control the text render based on the obtained configuration to obtain the bitmap image.

Example 21 includes a method for using cell phone font and associated cell phone font resource to display localized text characters on a vehicle display may include: providing a motor vehicle including in-vehicle equipment configured to render a set of one or more first character set and associated font and font sizes; providing a portable device including a component configured to render a second character set and associated font and font sizes that is not included in the set; downloading an application to the portable device.

Example 22 includes the subject matter of example 21, and an application of the portable device may be configured to: insert localized text into a view window on the portable mobile device according to the second character set and associated font and font sizes; capture a bitmap of the view window area; transmit an image of the captured bitmap over a removable wired connection to the motor vehicle or short range wireless connection to the motor vehicle to an in-vehicle component of the motor vehicle.

Most of the equipment discussed above comprises hardware and associated software. For example, the typical electronic device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. An automotive head unit installed in a motor vehicle, the automotive head unit comprising:
a screen; and
circuitry to render, for display on the screen, textual content using one or more first character sets of the automotive head unit, the circuitry configured to:
send text to a personal portable device located in the motor vehicle;
receive back image data to represent the text, the image data rendered by the personal portable device based on a second character set that is different than each character set of the one or more first character sets; and
cause the screen to display an image based on the received image data.

2. The automotive head unit of claim 1, wherein the personal portable device is a cell phone located in the motor vehicle.

3. The automotive head unit of claim 2, wherein the image data is received over a short range wireless connection.

4. The automotive head unit of claim 2, wherein the image data is received over a removable wired connection.

5. The automotive head unit of claim 1, wherein the text is associated with a character set of the one or more first character sets.

6. The automotive head unit of claim 1, the circuitry further configured to:
decompress the image data to recover data;
wherein said image is based on the recovered data.

7. The automotive head unit of claim 1, the circuity further configured to:
transmit a request including a characteristic to control rendering by the personal portable device;
wherein the image data is rendered responsive to the request.

8. The automotive head unit of claim 7, wherein the characteristic includes at least one of font, font size, or display area size.

9. A computer-implemented method comprising:
sending textual data to be displayed on a screen of a motor vehicle to an electronic device that is accessible to the motor vehicle via a wireless connection to utilize a font or character set resource of the electronic device;
receiving image data rendered by the electronic device based on the textual data using the font or character set resource of the electronic device; and
causing the screen of the motor vehicle to display an image based on the received image data.

10. The computer-implemented method of claim 9, wherein the font or character resource of the electronic device comprises a text renderer, and the computer-implemented method further comprises:
inputting the textual data into the text renderer; and
inputting data based on an output of the text rendered into an image creator of the electronic device to generate the image data.

11. A system, comprising:
a vehicle component that is installed in a motor vehicle, the vehicle component including a screen and an image renderer; and
a portable device configurable to establish a connection with the motor vehicle, the portable device including a text renderer and configured to, in response to receiving a command to generate an image for the vehicle component, perform first operations to:
input data associated with the command into the text renderer to obtain a bitmap image; and
transmit the bitmap image or a representation thereof to the vehicle component;
wherein the vehicle component is configured to perform second operations to:
input data of the bitmap image into the image renderer; and
display an output of the image renderer on the screen.

12. The system of claim 11, wherein the first operations are further to capture rendered text of a screen of the portable device to obtain the bitmap image.

13. The system of claim 11, wherein the first operations are further to capture rendered text of a view window associated with a memory of the portable device to obtain the bitmap image.

14. The system of claim 13, wherein the view window is of a predefined size.

15. The system of claim 11, wherein the first operations are further to compress the bitmap image to generate the representation of the bitmap image, and wherein the second operations are further to recover the bitmap image in response to receipt of the representation of the bitmap image.

16. The system of claim 11, wherein a memory of the portable device retains a superset of character sets stored on the vehicle component.

17. The system of claim 11, wherein a memory of the portable device stores a first character set utilized by the text renderer responsive to the input of the data, the first character set different than any second character sets stored on a memory of the motor vehicle.

18. The system of claim 11, wherein a memory of the portable device stores first font information corresponding to a font or font size, the first font information different than any second font information stored on any memory of the vehicle component, wherein the first font information is utilized by the text renderer responsive to the input of the data.

19. The system of claim 11, wherein the portable device is further configured to communicate with a backend to obtain configuration information and the first operations are further to control the text render based on the obtained configuration to obtain the bitmap image.

20. The system of claim 11, wherein the portable device are further to obtain configuration information from at least one of the motor vehicle or a remote server and the first operations are further to control the text render based on the obtained configuration to obtain the bitmap image.
